(19) United States
(12) Patent Application Publication
(10) Pub. No.: US 2002/0129685 A1
(43) Pub. Date: Sep. 19, 2002

(54) Apparatus for machining a workpiece

(75) Inventor: Bruno Schmitter, St. Louis, MO (US)

Correspondence Address: Christopher J. Hayes, BRYAN CAVE LLP, 211 N. Broadway, Suite 3600, St. Louis, MO, 63102-2750, US

(73) Assignee: Hydromat, Inc

(21) Appl. No.: 09/809,950

(22) Filed: Mar. 16, 2001

(51) Int. Cl. B23B 3/00; B23P 15/30

(52) U.S. Cl. 82/117; 82/142

(57) ABSTRACT

An apparatus for primary and secondary machining of a workpiece segment of a length of bar stock includes a lathe for primary machining of the workpiece and a rotary transfer machine for secondary machining of the workpiece. The lathe has a sliding headstock for rotating and advancing the bar stock and a rotatable drive collet for holding the bar stock. A rotatable guide bushing is aligned with the drive collet for supporting and clamping the bar stock. A tool holder is positioned adjacent to the guide bushing for holding one or more tools for primary machining of the workpiece. The rotary transfer machine receives the workpiece via a fixture aligned with the lathe and performs secondary machining of the workpiece.

### FIELD OF THE INVENTION

The present invention pertains to the field of automatic machining. More particularly, this invention relates to an apparatus for conducting primary and secondary machining operations on a workpiece.

### BACKGROUND OF THE INVENTION

Automatic lathes are commonly used to perform turning operations on a workpiece (e.g., recessing, contouring, single pointing, and heavy turning). The workpiece is typically gripped, rotated, and machined in multiple steps using a plurality of cutting tools. A commonly used type of lathe is a sliding-headstock or Swiss-type automatic lathe. A Swiss-type lathe generally comprises a sliding headstock, a guide bushing disposed in the direction of the movement of the headstock, and one or more tools for turning operations. The sliding headstock feeds a revolving piece of material through a guide bushing and then into the path of one or more radially mounted tools. The combination of the guide bushing and the radial tool mounting permits exceptionally fine control of the cut or other machining operation. The finished product is then discharged from the lathe and delivered to another machine if secondary machining operations are required.

Rotary transfer machines are commonly used to produce parts requiring a number of different machining operations. A rotary transfer machine intermittently indexes a workpiece about a vertical or horizontal axis to a series of toolspindle units that simultaneously perform various machining operations (e.g., drilling, cross drilling, boring, turning, milling, external and internal recessing, threading, tapping, broaching, etc.). Thus, the rotary transfer machine conducts a number of machining operations on a workpiece using a single machine.

The production of a part often requires both Swiss-type lathe operations and further machining operations by a rotary transfer machine. A significant disadvantage of machines available before the present invention is that lathe operations and rotary transfer operations have been performed by separate machines. The use of two separate machines has resulted in delays in production as parts must be transferred from one machine to the next. This transfer can significantly increase time and labor required for production. In addition, a third machine such as a pick and place or robot must be used to load parts finished by the lathe into the rotary transfer machine. The use of such additional machinery adds to the cost of production by requiring the purchase, operation and maintenance of a separate apparatus. Furthermore, pick and place machines and robots frequently do not accurately align the part such that it is straightly seated in the fixture of the rotary transfer machine. Such imperfect seating results in reduced accuracy and defective parts.

Another disadvantage of other approaches is that expensive ground bar stock usually must be used to produce precise parts. Less expensive drawn bar stock typically cannot be used because of surface and outer diameter (OD) irregularities. Because ground bar stock is more expensive, costs are substantially higher for production of parts requiring ground bar stock. Furthermore, ground bar stock must be handled with special care and packaging to avoid damaging the surface. This special care further adds to the cost of the final product.

Another shortcoming of prior approaches is the inability to provide accurate part concentricity, precise OD control, and consistent surface finishes without using separate machines to perform primary and secondary machining operations.

For the foregoing reasons, there is a need for a machine that can significantly reduce production cost by uniquely performing the operations of a sliding-headstock lathe and a rotary transfer machine to produce superior part concentricity, ultra-precise diameter control, and consistent surface finishes using less expensive drawn bar stock. There is also a need for a machine that can perform primary and secondary machining operations without a separate pick and place machine or robot to load the rotary transfer machine. The present invention provides these and other advantageous results.

### SUMMARY OF THE INVENTION

The machining apparatus described herein provides the advantages of a sliding-headstock lathe and a rotary transfer machine to produce superior part concentricity, ultra-precise diameter control, and consistent surface finishes.

The apparatus includes a lathe for primary machining of a workpiece segment of a length of bar stock and a rotary transfer machine for secondary machining of the workpiece segment. The lathe comprises a sliding headstock for rotating and advancing the bar stock. The sliding headstock comprises a rotatable drive collet for holding the bar stock. A rotatable guide bushing is aligned with the drive collet for supporting and clamping the bar stock. A tool holder is positioned adjacent to the guide bushing for holding one or more tools for primary machining of the workpiece segment. The rotary transfer machine receives the workpiece via a fixture aligned with the lathe and performs secondary machining of the workpiece segment. The apparatus may include a cutting device (e.g., a saw) for cutting the workpiece segment from the bar stock. The rotary transfer machine comprises an indexing table having a plurality of stations, each station having a stationary fixture (e.g., a collet) for holding a workpiece.

In certain embodiments, the apparatus preferably further includes a beam assembly for attaching the lathe to the rotary transfer machine. The beam assembly comprises a plurality of slides attached to the upper surface of the ring encircling the indexing table for sliding the lathe toward and away from a fixture of the rotary transfer machine aligned to receive the workpiece segment. A motor actuates a drive for moving the lathe along the slides.

The present invention allows very precise parts to be produced using drawn bar stock. Previously, such parts generally had to be produced using more expensive ground bar stock, which had to be handled with special care to avoid damaging its surface. The need to use ground bar stock and to handle bar stock with special care and packaging is obviated by the present invention. The present invention provides the ability to do Swiss-type turning at the in-feed station of a rotary transfer machine, which allows stock to be turned for better outer diameter (OD) control, eliminating the variability of cold drawn bar stock while also providing better roundness than ground bar stock. The apparatus can therefore consistently produce parts having the same precise OD tolerances.

The present invention enables the user to do additional operations such as heavy recessing and turning and single-pointing in the lathe station before the part is cut off and clamped. This capability significantly expands the capacity of a typical multi-station rotary transfer machine offering more operations than previously possible, reducing the need for secondary operations and opening up the potential for a wider variety of applications and the production of more complex parts.

In addition, the ability of the machining apparatus of the present invention to rotate bar stock at the in-feed of a rotary transfer machine can reduce cutoff time. Generally, a stationary part must be cutoff by cutting through the diameter of the part. However, a rotating part may be cut part way into the radius. The stock may then be moved through the collet and into the first fixture of the rotary transfer machine. Once it is clamped, the remaining material may be cut through. This two-step cut off takes less time and ensures precise alignment.

Yet another benefit of the machining apparatus of the present invention is that it eliminates the need for a separate pick and place machine or robot. Because the apparatus loads the workpiece directly from the lathe into the rotary transfer machine, there is no need for a separate pick and place or robot to load parts into the rotary transfer machine. Furthermore, the alignment of the lathe and the rotary transfer machine ensures proper alignment of the workpiece in the fixture of the rotary transfer machine. Straight seating of the workpiece results in higher precision and reduces the number of defective parts.

### DRAWINGS

These, and other features, aspects and advantages of the present invention will become more fully apparent from the following detailed description, appended claims, and accompanying drawings where:

FIG. 1 is a partially broken-away prospective view of an apparatus for primary and secondary machining of a workpiece;

FIG. 2 is a partial longitudinal sectional side view of an apparatus for primary and secondary machining of a workpiece;

FIG. 3 is a schematic top view of an apparatus for primary and secondary machining of a workpiece;

FIG. 4 is a prospective view of a presently preferred embodiment of the synchronizing mechanism; and

FIG. 5 is a prospective view of an apparatus for primary and secondary machining of a workpiece segment of a length of bar stock having a sliding mechanism.

For simplicity and clarity of illustration, the drawing figures illustrate the general manner of construction, and descriptions and details of well-known features and techniques are omitted to avoid unnecessarily obscuring the invention.

### DETAILED DESCRIPTION OF THE INVENTION

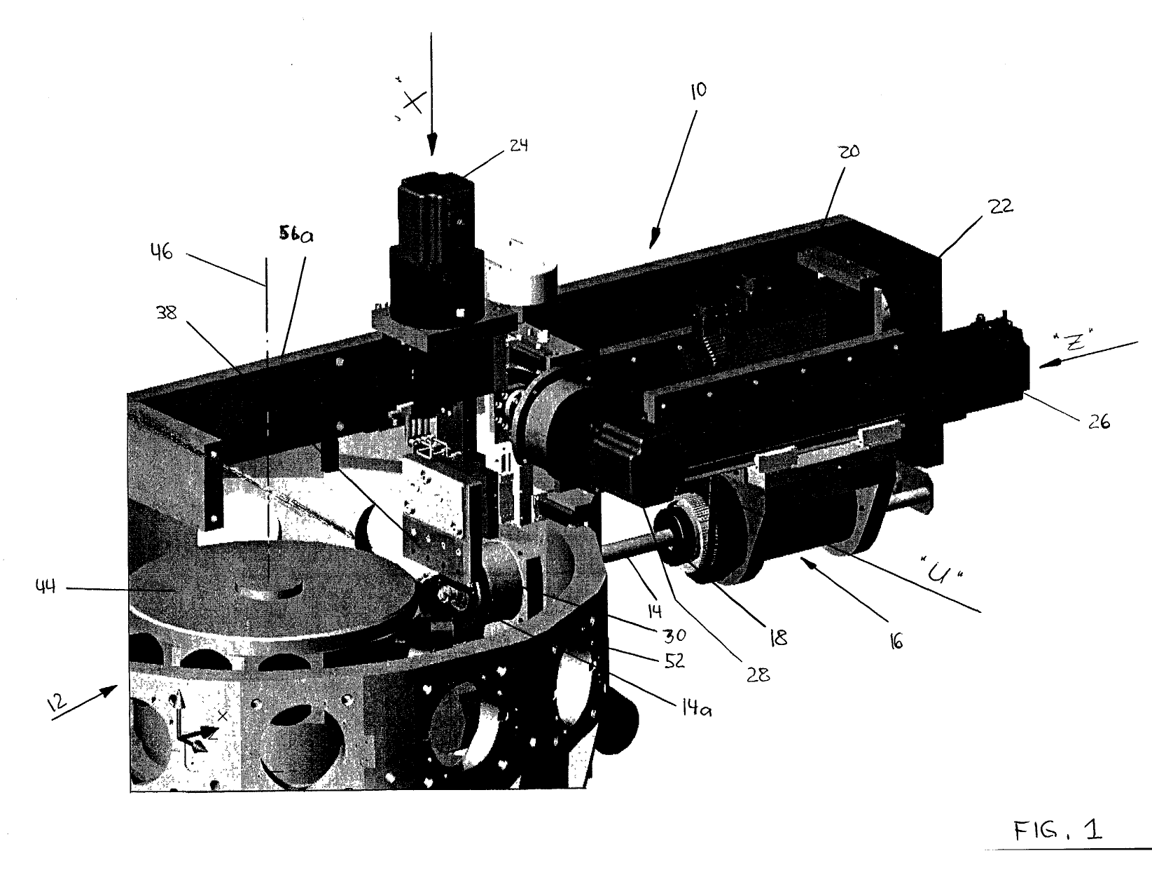

FIGS. 1, 2, 3 and 5 illustrate an apparatus for primary and secondary machining of a workpiece segment of a length of bar stock. As used herein, the terms primary and secondary machining refer to two stages of machining operations performed by the apparatus. The first stage of machining is performed by lathe 10 and the second stage of machining is performed by rotary transfer machine 12. Lathe 10 permits Swiss-type turning of a length of rotating bar stock 14 prior to cutoff and clamping of a workpiece segment 14a of the length of bar stock 14. Following cutoff and clamping, secondary machining operations are performed on the workpiece 14a by the rotary transfer machine 12.

The bar stock 14 is typically comprised of drawn or ground metal bar stock. For example, a presently preferred embodiment of the apparatus is adapted to machine bar stock having a maximum diameter of 32 mm and a maximum length of 12 feet.

The lathe 10 comprises a sliding headstock 16 for rotating and advancing the bar stock 14. The sliding headstock 16 comprises a rotatable drive collet 18 for holding the bar stock 14.

The drive collet 18 is rotated by main spindle drive motor 20 via main spindle drive assembly 22. One embodiment, the main spindle drive motor 20 is an AC servomotor with an optional brake. Main spindle drive assembly 22 is preferably a belt-drive assembly.

The lathe 10 also includes motor 26 actuating a drive for moving the sliding headstock 16 along the “Z” axis. Motor 24 actuates a drive for moving tool holder 38 along the “X” axis. Motor 28 actuates a drive for moving tool holder 38 along the “U” axis. In a presently preferred embodiment, X-axis motor 24 and U-axis motor 28 are 0.75 kilowatt (1.0 horsepower) AC servomotors with brakes, producing a rapid feed rate of 20 meters per minute. The Z-axis motor 26 is preferably a 1.50 kilowatt (2.0 horsepower) AC servomotor with a brake, producing a rapid feed rate of 20 meters per minute. The motors 24, 26 and 28 preferably each actuate a ball screw drive assembly (not shown). Other motors may be used in conjunction with the invention in certain applications. A lubrication unit with individual metering valves (not shown) provides ample lubrication of the roller guides and the ball screws. The motors 24, 26 and 28 are sized to avoid damage during crash and/or over-travel situations so as to avoid the need for overload couplings. A home switch (not shown) may be included for each axis (X, U and Z).

The lathe 10 further includes a rotatable guide bushing 30 for supporting and clamping the bar stock 14 to facilitate the cutting of the bar stock 14 to separate the workpiece segment 14a from the remainder of the bar stock 14. The guide bushing assembly is positioned at or near the in-feed of the rotary transfer machine 12. The guide bushing 30 is protected by an air/oil mist lubrication circuit (not shown). The guide bushing 30 features hydraulic actuated clamping with an adjustable bushing pre-load force of 0.5-5 bar and a possible clamping force up to 60 bar.

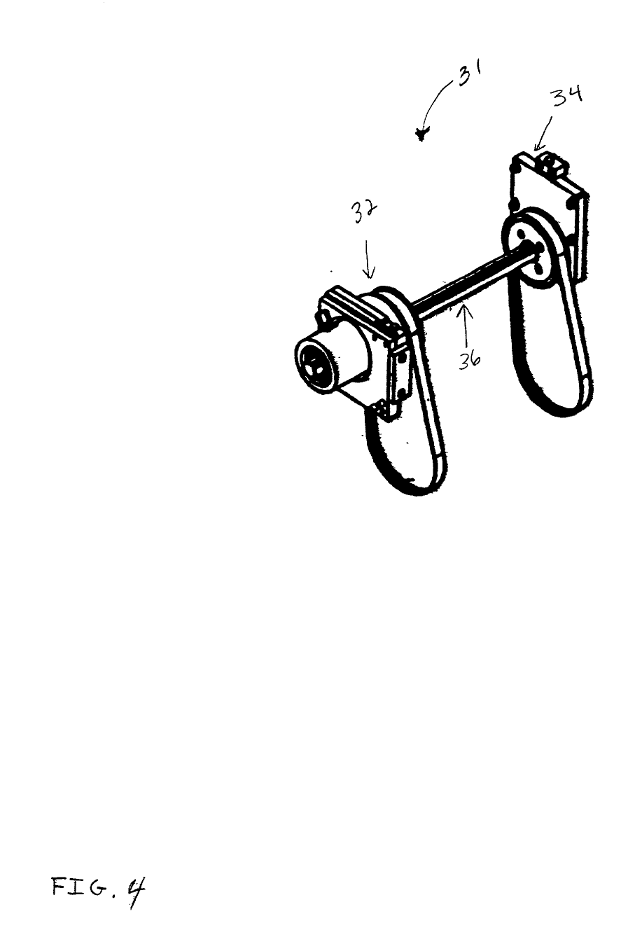

The rotation of the guide bushing 30 is synchronized with the rotation of the drive collet 18 by a synchronizing mechanism 31 shown in FIG. 4. The synchronizing mechanism 31 causes the drive collet 18 and the guide bushing 30 to rotate at the same time and at the same speed. FIG. 4 is a prospective view illustrating a presently preferred embodiment of the synchronizing mechanism 31. A first belt-drive mechanism 32 is engaged with the main spindle drive (not shown) for transferring rotary motion from the main spindle drive. A second belt-drive mechanism 34 is engaged with the guide bushing (not shown) for transferring rotary motion to the guide bushing. A shaft 36 connects the first belt-drive mechanism 32 to the second belt-drive mechanism 34, such that rotary motion is transferred from the main spindle drive to the guide bushing. As such, the main spindle drive rotates both the drive collet (as described above) and the guide bushing so that both mechanisms are synchronized.

Referring again to FIGS. 1, 2, 3 and 5, the lathe 10 further comprises a tool holder 38 for holding one or more tools 38a-38d for primary machining of the workpiece segment 14a of the length of bar stock 14. The tools can perform turning operations (e.g., recessing, contouring, single pointing and heavy turning, etc.). The tool holder 38 may take many forms, for example, in one embodiment, tool holder 38 is a gang tool holder plate. The gang tool plate has four ¾ inch tool holders for holding four tools 38a-38d. Alternatively, each tool may be held on a separate tool assembly mounted to the tool holder, which allows each tool to be changed separately. Special machining and tooling forms (e.g., drilling, center drilling, burnishing, knurling, etc.) may be used with separate tool assembly holders.

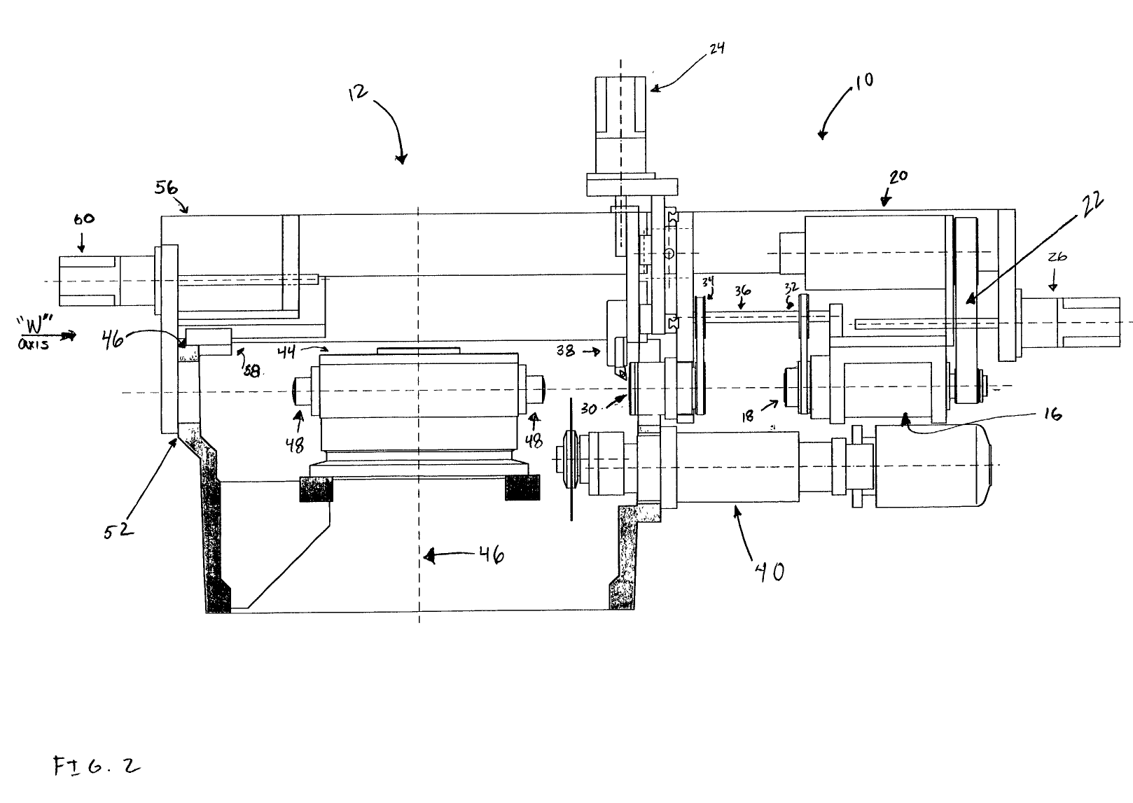

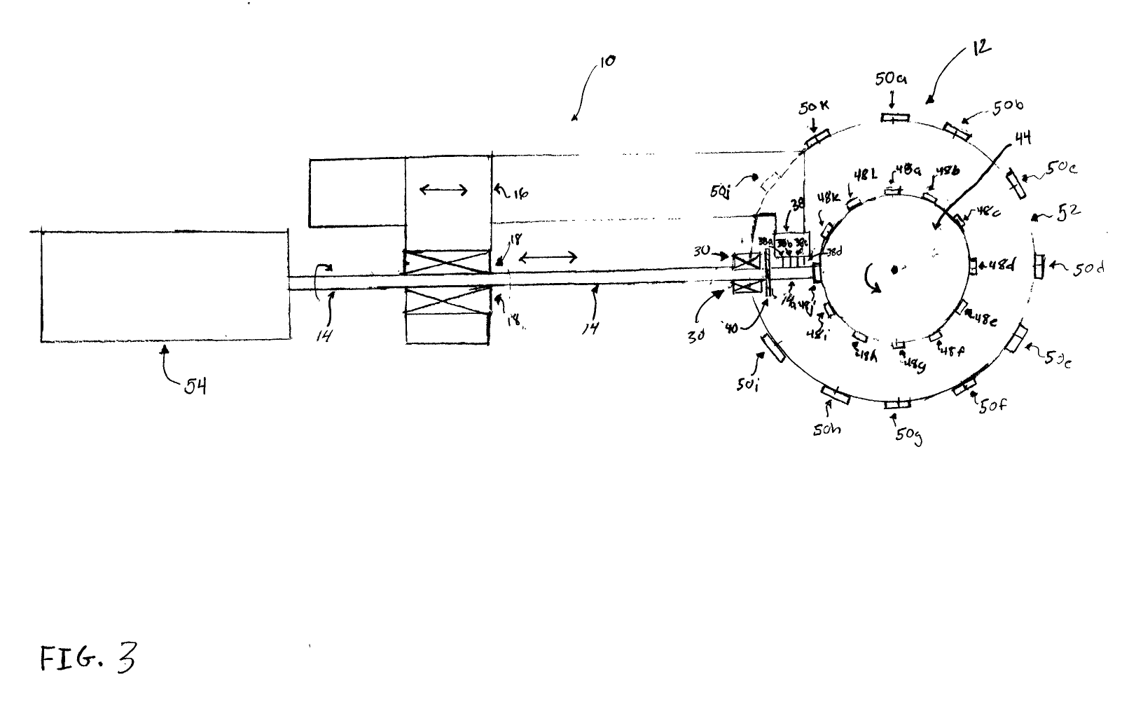

The apparatus further includes a cutting device 40 (shown in FIGS. 2 and 3) for cutting the bar stock 14 to separate the workpiece segment 14a from the rest of the bar stock 14, allowing the separated workpiece segment 14a to undergo secondary machining operations in the rotary transfer machine 12. Cutting device 40 may be a saw or any other device suitable for cutting bar stock. Preferably, one of the tools held by tool holder 38 is used to partially cut the workpiece segment 14a from the length of bar stock to reduce the time required for the cutting device 40 to cut off the workpiece segment.

The workpiece 14a is fed into one of a plurality of fixtures 48a-48l of rotary transfer machine 12 and cut off of the length of bar stock 14 for secondary machining operations. Rotary transfer machine 12 is a conventional rotary transfer machine that intermittently indexes the cut-off workpiece about a vertical or horizontal axis to a series of toolspindle units that perform various, simultaneous machining operations (e.g., drilling, cross drilling, boring, turning, milling, external and internal recession, threading, tapping, broaching, etc.). The rotary transfer machine 12 comprises a rotary indexing table 44 that rotates intermittently around a vertical or horizontal axis 46. A plurality of fixtures 48a-48l, each for holding one workpiece, are located on the periphery of the indexing table 44. The term fixture is intended to broadly include any of a wide variety of devices for holding and/or supporting the workpiece during secondary machining operations (e.g., a collet, chuck, expanding sleeve, mandrel, or any other clamping configuration). A plurality of toolspindle units 50a-50k are mounted on a ring 52 that encircles the indexing table. In a presently preferred embodiment, the rotary transfer machine is a HYDROMAT® model HB-45 CNC. Other rotary transfer machines can also be used.

As shown in FIG. 3, the apparatus includes a hydrostatic bar feeder 54 for feeding bars to the sliding headstock unit 16 of lathe 10. The bar feeder 54 preferably comprises a fixed nose (not shown) having the same ID as the guide channel of the lathe 10 to facilitate the feed-in of the bar stock 14 to the sliding headstock unit 16.

Referring to FIG. 1, lathe 10 is preferably attached to the rotary transfer machine 12 by assembly 56. Assembly 56 comprises one or more beams 56a attached to the upper surface of ring 52 of the rotary transfer machine 12 (a second beam 56b parallel to beam 56a is not shown in FIG. 1 to reveal the sliding headstock mechanism behind the beam). However, it should be emphasized that lathe 10 may be attached to rotary transfer machine 12 by any of a number of means that aligns the lathe 10 to feed a workpiece segment into one of fixtures 48a-48l of the rotary transfer machine 12.

The present invention preferably further includes a slide mechanism for sliding the lathe toward and away from the fixture of the rotary transfer machine aligned to receive the workpiece segment. The primary function of the slide mechanism is to reduce the size of the unusable remnant or “rest piece” that is left at the end of a length of bar stock 14. The rest piece produced by the apparatus of the present invention is extended by the length between the front position of the guide bushing 30 and one of fixtures 48a-48l of the rotary transfer machine. The slide mechanism reduces the length of the rest piece. After primary machining operations on the last segment prior to the rest piece, the slide moves the lathe toward the fixture 48 of the rotary transfer machine 12 so that the work piece segment 14a can be inserted into the fixture 48. After insertion into one of fixtures 48a-48l, the work piece segment 14a is then cut, and the lathe 10 slides back away from the fixture. By moving the lathe 10 toward and away from the fixture, the length of the rest piece or remnant can be significantly reduced, preferably to a length of approximately 200 millimeters.

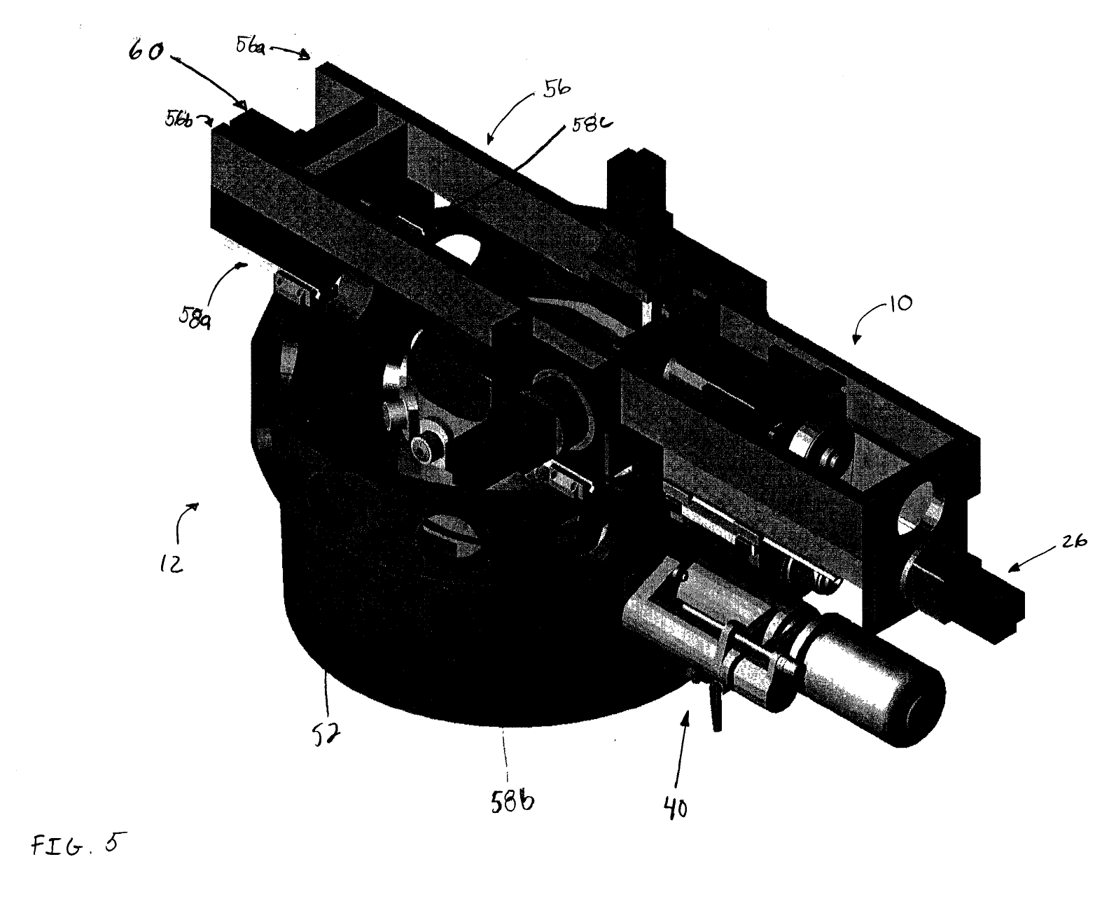

FIG. 5 shows a presently preferred embodiment of the slide mechanism. Lathe 10 is attached to rotary transfer machine 12 by assembly 56. Assembly 56 comprises one or more beams 56a and 56b. One or more roller bearing slides 58a, 58b, 58c and fourth bearing slide (not shown in FIG. 5) are positioned between assembly 56 and the upper surface of ring 52. Slide drive motor 60 preferably actuates a ball screw drive that slides assembly 56 horizontally across ring 52 to thereby slide lathe 10 toward and away from one of fixtures 48a-1 that is aligned to receive the workpiece.

Although the invention has been described with reference to specific embodiments, it will be understood by those skilled in the art that various changes may be made without departing from the spirit or scope of the invention. For instance, the numerous details set forth herein, for example, details relating to the configuration and operation of the presently preferred embodiment of the lathe and rotary transfer machine, are provided to facilitate the understanding of the invention and are not provided to limit the scope of the invention. Accordingly, the disclosure of embodiments of the invention is intended to be illustrative of the scope of the invention and is not intended to be limiting. It is intended that the scope of the invention shall be limited only to the extent required by the appended claims.

I claim:

1. An apparatus for primary and secondary machining of a workpiece segment of a length of bar stock, the apparatus comprising:
a lathe for primary machining of the workpiece segment, the lathe comprising:
a sliding headstock for rotating and advancing the bar stock, the sliding headstock comprising a rotatable drive collet for holding the bar stock;
a rotatable guide bushing aligned with the drive collet for supporting and clamping the bar stock;
a tool holder adjacent to the guide bushing for holding one or more tools for primary machining of the workpiece segment; and
a rotary transfer machine for secondary machining of the workpiece segment; the rotary transfer machine having a plurality of fixtures for receiving the workpiece segment from the lathe.

2. The apparatus of claim 1, further comprising an attaching assembly for attaching the lathe to the rotary transfer machine.

3. The apparatus of claim 2, wherein the rotary transfer machine further comprises an indexing table and a ring encircling the indexing table, and wherein the attaching assembly comprises one or more beams attached to the ring.

4. The apparatus of claim 2, wherein the attaching assembly further comprises a slide mechanism for sliding the lathe toward and away from a fixture of the rotary transfer machine aligned to receive the workpiece segment.

5. The apparatus of claim 4, wherein the rotary transfer machine further comprises an indexing table and a ring encircling the indexing table, and wherein the slide mechanism comprises one or more slides on the upper surface of the ring encircling the indexing table.

6. The apparatus of claim 4, further comprising a motor actuating a drive for moving the lathe along the slide mechanism.

7. The apparatus of claim 1, further comprising a synchronizing mechanism for synchronizing the rotation of the drive collet with the rotation of the guide bushing.

8. The apparatus of claim 1, further comprising a cutting device adjacent to the guide bushing for cutting the workpiece segment from the length of bar stock.

9. The apparatus of claim 1, wherein the sliding headstock comprises one or more motors actuating one or more drives for moving the sliding headstock along one or more axes.

10. The apparatus of claim 1, wherein the lathe further comprises a motor actuating a drive for moving the tool holder along one or more axes.

11. The apparatus of claim 1, further comprising a bar feed for feeding the length of bar stock to the sliding headstock.

12. An apparatus for primary and secondary machining of a workpiece segment of a length of bar stock, the apparatus comprising:
a lathe for primary machining of the workpiece segment, the lathe comprising:
a sliding headstock for rotating and advancing the bar stock, the sliding headstock comprising a rotatable drive collet for holding the bar stock;
a rotatable guide bushing aligned with the drive collet for supporting and clamping the bar stock;
a synchronizing mechanism for synchronizing the rotation of the drive collet with the rotation of the guide bushing; and
a tool holder adjacent to the guide bushing for holding one or more tools for primary machining of the workpiece segment;
a saw adjacent to the guide bushing for cutting the workpiece segment from the length of bar stock to allow for secondary machining;
a rotary transfer machine for secondary machining of the workpiece segment; the rotary transfer machine comprising a plurality of fixtures for receiving the workpiece segment from the lathe; an indexing table; and a ring encircling the indexing table;
an assembly for attaching the lathe to the rotary transfer machine, the assembly comprising a plurality of slides attached to the upper surface of the ring for sliding the lathe toward and away from a fixture of the rotary transfer machine aligned to receive the workpiece segment, and
a motor actuating a drive for moving the lathe along the slides.

13. A lathe for machining a workpiece segment of a length of bar stock and adapted to cooperate with a rotary transfer machine, the lathe comprising:
a sliding headstock for rotating and advancing the bar stock, the sliding headstock comprising a rotatable drive collet for holding the bar stock;
a rotatable guide bushing aligned with the drive collet for supporting and clamping the bar stock;
a tool holder adjacent to the guide bushing for holding one or more tools for primary machining of the workpiece segment; and
an assembly for attaching the lathe to the rotary transfer machine such that a fixture of the rotary transfer machine is aligned to receive the workpiece segment from the lathe.

14. The apparatus of claim 13, wherein the attaching assembly comprises one or more beams attached to the rotary transfer machine.

15. The apparatus of claim 14, further comprising one or more slides positioned between the beams and the rotary transfer machine for sliding the lathe toward and away from the fixture of the rotary transfer machine aligned to receive the workpiece segment.

16. The apparatus of claim 13, wherein the assembly for attaching the lathe further comprises a slide mechanism attached to the rotary transfer machine for sliding the lathe toward and away from the fixture of the rotary transfer machine aligned to receive the workpiece segment.

17. The apparatus of claim 16, further comprising a motor actuating a drive for moving the lathe along the slide mechanism.

18. The lathe of claim 13, further comprising a synchronizing mechanism for synchronizing the rotation of the drive collet with the rotation of the guide bushing.

19. The lathe of claim 13, wherein the sliding headstock comprises one or more motors actuating one or more drives for moving the sliding headstock along one or more axes.

20. The apparatus of claim 1, wherein the lathe comprises a motor actuating a drive for moving the tool holder along an axis.

21. A lathe for machining a workpiece segment of a length of bar stock and adapted to cooperate with a rotary transfer machine, the lathe comprising:
a sliding headstock for rotating and advancing the bar stock, the sliding headstock comprising a rotatable drive collet for holding the bar stock;
a rotatable guide bushing aligned to receive the workpiece segment and aligned with the drive collet for supporting and clamping the bar stock; and
a tool holder adjacent to the guide bushing for holding one or more tools for primary machining of the workpiece segment; and
one or more beams for attaching the lathe to the rotary transfer machine such that one of a plurality of fixtures of the rotary transfer machine is aligned to receive the workpiece segment from the lathe,
one or more slides connected to the beams for sliding the lathe toward and away from the fixture of the rotary transfer machine aligned to receive the workpiece segment; and
a motor actuating a drive for sliding the lathe along the slides.
